(19) United States
(12) Patent Application Publication
(10) Pub. No.: US 2013/0181095 A1
(43) Pub. Date: Jul. 18, 2013

(54) DEVICE TO GENERATE LIFT FORCE (OPTIONS)

(71) Applicant: Alibi Akhmejanov, Uralsk City (KZ)

(72) Inventor: Alibi Akhmejanov, Uralsk City (KZ)

(21) Appl. No.: 13/823,317

(22) PCT Filed: Jun. 6, 2011
(86) PCT No.: PCT/KZ11/00010

§ 371 Date: Mar. 14, 2013

(30) Foreign Application Priority Data
Dec. 27, 2010 (KZ) 2010/1787.1

(51) Int. Cl. B64C 39/06

(52) U.S. Cl. CPC B64C 39/062
USPC 244/23 C

(57) ABSTRACT

The options of the invention relate to the aviation and can be used in order to create lifting vehicle as well as load lifting devices. In order to achieve technical result—the decrease of energy losses on the while creating and change of vector of moving, aerodynamic, composite force, including as a component a lift force,—in the device to generate lift force containing a tubiform frame, superchargers, the wings having in section an aerofoil profile oriented by the leading edge to the direction of working medium exhaust out of the super-charger, adjusting units for a wing, guiding devices, each of those is installed in front of leading edge of each wing, the system to maintain the required working temperature of medium, unit to connect outdoor environment, as per the invention in the first option of the device a tubiform frame is of the form of a tore, in the second option—the form of closed volumetric loop, in the third option—a cylindrical form. Meanwhile each option of the device is equipped with relevant distinguishing units, providing the achieving of a technical result.

### TECHNICAL FIELD

The invention relates to the aviation and can be used in order to create lifting vehicle as well as load lifting devices.

### BACKGROUND ART

It is known the device to generate lift force in the form of lifting vehicle, in which between the bottoms and the tops of round frame, which contain center superchargers in the shape of horizontally located ventilators, in the zone of annular plenum the annular wing in the form of upturned plate with a shape flat-convex in section is fixed, a lifting vehicle in order to intake air contains bottom and top air inlet ducts (a unit to connect outdoor environment), steering flappers and power device (driving motor) for a supercharger (Patent RU N22061627 , IPC C1 5B64 C29/00 dated 10 Jun. 1996). Lift force is derived due to the unsymmetrical flow-around of a wing (Physics encyclopedia/Head Editor A. M. Prokhorov.—Moscow: Soviet encyclopedia, 1983.-928 pages; Krasnov N. F. Aerodynamics. Part I. Theoretic framework. Aerodynamics of a profile and a wing. Textbook for high technical schools.—M., Vysshaya Shkola, 1976.—384 pages; Krasnov N. F. Aerodynamics Part II. Methods of aerodynamic design. Textbook for high technical schools—3-rd edition, revised and corrected—M., Vysshaya Shkola, 1980.—416 pages), meanwhile the above mentioned device is characterized with ineffective control of change of vector of moving, aerodynamic, composite force, including as a component a lift force, ineffective control of space motion, what is caused by restriction of degree of freedom of travel of such units as a fixed annular wing, steering flappers.

It is known the device to generate lift force (Innovation patent of Republic of Kazakhstan N222499, IPC B64C 29/00 dated 17 May 2010), containing a frame, a super-charger with driving motor is rigidly connected with a frame, the annular wing having in section an aerofoil profile, the frame is divided into zones in horizontal direction with partitions, and the frame together with an annular wing fixed in the zone, is divided into sectors in vertical direction with partitions, the device contains a supercharger and distribution tools in the side and in the center, in front of a leading edge of an annular wing in each sector the guiding device is installed, the device is equipped with adjusting units and the system to maintain the required working temperature of medium in the form of heat exchanger and/or inlet-exhaust tool (unit to connect outdoor environment).

The most similar analogue—prototype is two options of the device to generate lift force, the structures of which are described in the information source (Innovation patent of Republic of Kazakhstan N223001, IPC B64C 29/00 dated 15 Oct. 2010) and with the help of which the realization of option of generating of lift force through medium flow arrangement in order to flow about wings over closed loop path is realized. Both options of prototype device contain tubiform frame, supercharges with driving motors, the wings having in section an aerofoil profile oriented by the leading edge to the direction of working medium exhaust out of the supercharger, adjusting units for a wing, guiding devices, each of those is installed in front of leading edge of each wing, the system to maintain the required working temperature of medium in the form of heat exchanger and/or inlet-exhaust tool (unit to connect outdoor environment). Meanwhile in case of prototype device according to the first option, it has a tubiform frame in the shape of a tore, and in case of prototype device according to the second option, it has a tubiform frame in the shape of closed volumetric loop converged without crossing in the center of device to deflect the path of working medium transmission, and it is additionally equipped with a central distribution unit, which is required to arrange medium flow along the specified closed loop path. (Here should be noted, that, although Document of title for invention (Innovation Patent of Republic of Kazakhstan N223001, IPC B64C 29/00 dated 15 Oct. 2010) issued for the object <<method>>, from this it is found out, became known a prototype device for the applied object <<device>>. In the information source (Innovation patent of Republic of Kazakhstan N223001, IPC B64C 29/00 dated 15 Oct. 2010) it is shown the description of a construction of the specified prototype device (both options), with the help of which the realization of option of generating of lift force through medium flow arrangement in order to flow about wings over closed loop path is carried out, the method of use (application), its operation (performance) id described. This prototype if the mean of the same application as a suggested invention, it is known from source (Innovation patent of Republic of Kazakhstan N223001, IPC B64C 29/00 dated 15 Oct. 2010), is characterized with accumulation of characteristic features, which is the most similar to accumulation of essential features of applied object).

In the known objects superchargers can be different—centrifugal, axial etc., and a force device for superchargers can be in the form of diverse driving motors (New polytechnical dictionary/Head editor A. Yu. Ishlinskiy —Moscow: Science publishing office <<Bolshaya Rossiyskaya Entsiklopediya>>, 2000.—671 pages).

Common disadvantages of specified analogues are high energy losses while creating and change of vector of moving, aerodynamic, composite force, including as a component a lift force, due to increased negative effect of arising distributed aerodynamic forces on the surface of feedthrough, which arise as <<induced>> (or <<inductive>>) aerodynamic forces, and increased negative effect disturbed nonstationary (turbulent) slip stream near the surface of feedthrough on the condition of flow about wings and generating of lift force. One of the main reasons of these disadvantages consists in the absence of optimization of some design parameters, which influences the nature of motion of working medium.

### SUMMARY OF INVENTION

The aim of invention is achieving of technical result: reduction of energy losses on the creating and change of vector of moving, aerodynamic, composite force, including as a component force a lift force. One of the means to reach this is the below introduced optimization of some design parameters, which influences the nature of motion of working medium.

The technical result in the applied first option of a device, in which the principles of invention are realized, is achieved in the fact that the device to generate lift force containing a tubiform frame in the form of a tore, supercharges with driving motors, the wings having in section an aerofoil profile oriented by the leading edge to the direction of working medium exhaust out of the supercharger, adjusting units for a wing, guiding devices, each of those is installed in front of leading edge of each wing, the system to maintain the required working temperature of medium, unit to connect outdoor environment, according to invention is equipped with more than one wing, inside the in front of the leading edge of each wing as per the method <<tube in tube>> rigidly connected with a frame separating tubiform elements, which separate for working medium the through passage area into peripheral and central parts are installed, meanwhile a section area of a central part of through passage area inside separating tubiform element S₁ is connected with a wing area S₂ by a condition S₁/S₂ makes a value, which is in the limits not less 0.3 and not more 3.6, and the largest area of cross section area of a wing by a plane, passing through the longest height of wing shape, is inserted in the section of a central part of the through passage area, guiding devices are installed inside each separating tubiform element in its inlet flow part and rigidly connected with these elements, at the parts where the flow turns the additional separating tubiform elements, equipped from inside of inlet part with the system to maintain the required working temperature of medium are installed, the distance L₁ from the area of flow outlet from the separating tubiform element up to the leading edge of a wing is connected with a wing chord b by condition L₁ makes a value, which is within the limits not less 0.8b and not more 2.5b, but a distance L₂ from a wing trailing edge up to the flow inlet into separating tubiform element or into the additional separating tubiform element makes a value, which is within the limits not less 0.7b and not more 3b, main superchargers, oriented by the working medium outlet from the supercharger toward the direction of a wing leading edge, are installed in front of the guiding devices inside the separating tubiform elements in the center and rigidly connected with these elements, meanwhile each wing complies with one main supercharger, but a peripheral superchargers, oriented by the working medium outlet from the supercharger toward the direction of a wing leading edge, are installed in the extent of area, restricted by a frame and separating tubiform elements and rigidly connected with a frame, meanwhile each wing complies with one peripheral supercharger.

The technical result in the applied second option of a device, in which the principles of invention are realized, is achieved in the fact that the device to generate lift force containing a tubiform frame in the shape of closed volumetric loop, converged without crossing in the center of device to deflect the path of working medium transmission supercharges with driving motors, the wings having in section an aerofoil profile oriented by the leading edge to the direction of working medium exhaust out of the supercharger, adjusting units for a wing, guiding devices, each of those is installed in front of leading edge of each wing, the system to maintain the required working temperature of medium, unit to connect outdoor environment, according to invention is equipped with more than one wing, inside the frame in front of the leading edge of each wing as per the method <<tube in tube>> rigidly connected with a frame separating tubiform elements, which separate for working medium the through passage area into peripheral and central parts are installed, meanwhile a section area of a central part of through passage area inside separating tubiform element S₁ is connected with a wing area S₂ by a condition S₁/S₂ makes a value, which is in the limits not less 0.3 and not more 3.6, and the largest area of cross section area of a wing by a plane, passing through the longest height of wing shape, is inserted in the section of a central part of the through passage area, guiding devices are installed inside each separating tubiform element in its inlet flow part and rigidly connected with these elements, at the parts where the flow turns the additional separating tubiform elements, equipped from inside of inlet part with the system to maintain the required working temperature of medium are installed, the distance L₁ from the area of steam outlet from the separating tubiform element up to the leading edge of a wing is connected with a wing chord b by condition L₁ makes a value, which is within the limits not less 0.8b and not more 2.5b, but a distance L₂ from a wing trailing edge up to the flow inlet into separating tubiform element or into the additional separating tubiform element makes a value, which is within the limits not less 0.7b and not more 3b, the device in the center is additionally furnished with a central distribution unit in order to change the path of peripheral and central steams, the main superchargers, oriented by the working medium outlet from the supercharger toward the direction of a wing leading edge, are installed in front of the guiding devices inside the separating tubiform elements in the center and rigidly connected with these elements, meanwhile each wing complies with one main supercharger, but a peripheral superchargers, oriented by the working medium outlet from the supercharger toward the direction of a wing leading edge, are installed in the extent of area, restricted by a frame and separating tubiform elements and rigidly connected with a frame, meanwhile each wing complies with one peripheral supercharger.

The technical result in the applied third option of a device, in which the principles of invention are realized, is achieved in the fact that the device to generate lift force containing a tubiform frame, supercharges with driving motors, the wings having in section an aerofoil profile oriented by the leading edge to the direction of working medium exhaust out of the supercharger, adjusting units for a wing, guiding devices, each of those is installed in front of leading edge of each wing, the system to maintain the required working temperature of medium, unit to connect outdoor environment, according to invention a tubiform frame has a cylindrical form with the end elements, having inside profiled surfaces in order to provide the turn back of working medium flow at 180°, the device is equipped with more than one wing; inside the frame in front of the leading edge of each wing as per the method <<tube in tube>> rigidly connected with a frame separating tubiform elements, which separate for working medium the through passage area into peripheral and central parts are installed, meanwhile a section area of a central part of through passage area inside separating tubiform element S₁ is connected with a wing area S₂ by a condition S₁/S₂ makes a value, which is in the limits not less 0.3 and not more 3.6, and the largest area of cross section area of a wing by a plane, passing through the longest height of wing shape, is inserted in the section of a central part of the through passage area, guiding devices are installed inside each separating tubiform element in its inlet flow part and rigidly connected with these elements, at the parts where the flow turns the additional separating tubiform elements, equipped from inside of inlet part with the system to maintain the required working temperature of medium are installed, the distance L₁ from the area of flow outlet from the separating tubiform element up to the leading edge of a wing is connected with a wing chord b by condition L₁ makes a value, which is within the limits not less 0.8b and not more 2.5b, but a distance L₂ from a wing trailing edge up to the steam inlet into separating tubiform element or into the additional separating tubiform element makes a value, which is within the limits not less 0.7b and not more 3b, in the extent of area, restricted by a frame and separating tubiform elements, as per the method <<tube in tube>> the tubiform partition is installed, rigidly connected with a frame and which together with end elements serves to arrange medium closed loop path, main superchargers, oriented by the working medium outlet from the supercharger toward the direction of a wing leading edge, are installed in front of the guiding devices inside the separating tubiform elements in the center and rigidly connected with these elements, meanwhile each wing complies with one main supercharger, but a peripheral superchargers, oriented by the working medium outlet from the supercharger toward the direction of a wing leading edge, are installed in the extent of area, restricted by a tubiform partition and separating tubiform elements and rigidly connected with a frame, meanwhile each wing complies with one peripheral supercharger.

Thus, all the applied options of a device are connected between each other insomuch that they constitute the sole inventive conception.

Character of invention is explained by schematically drawings describing these three applied options, which differ as per design features depending on type of arrangement of a closed movement of a working medium in the device. Bellow the diagrams of ones of the best invention implementations are introduced.

### BRIEF DESCRIPTION OF DRAWINGS

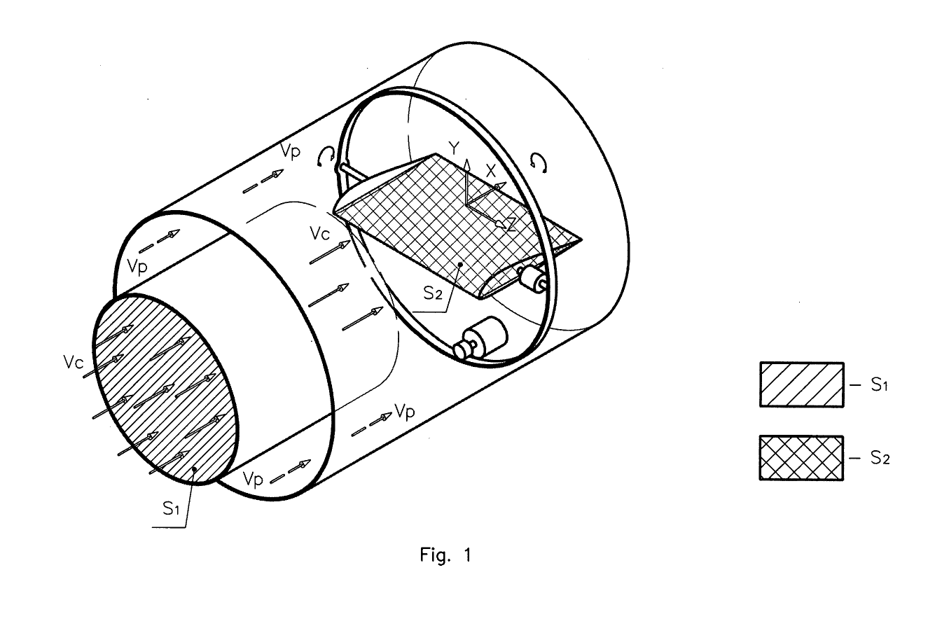

In FIG. 1 the diagram of the main part of device is introduced, which is existing in all the three options of a device, in which the principle of generating and administration of aerodynamic force is shown; meanwhile areas S₁ and S₂ are graphically shown. Here should be noted, that the wing area S₂ is an area of a wing projection on a base plane of a wing and is a characteristic value (GOST 22833-77. Characteristics of an aircraft geometric. Terms, definitions and letter designation)

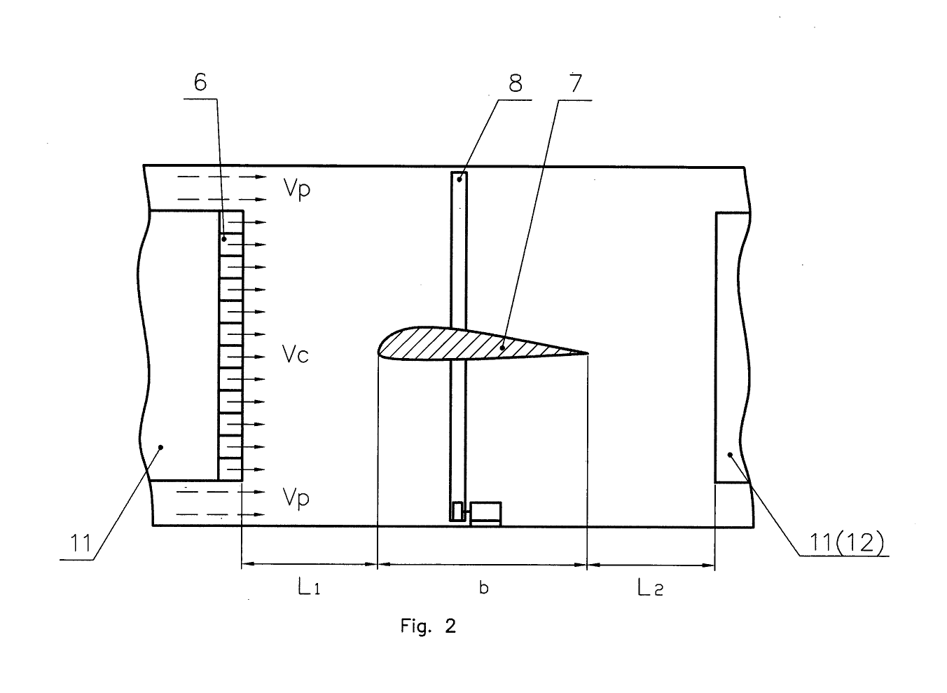

In FIG. 2 the incised side view of a main part of a device is introduced, which is available in all three options of a device, and values L ₁ , L₂ and b are graphically shown.

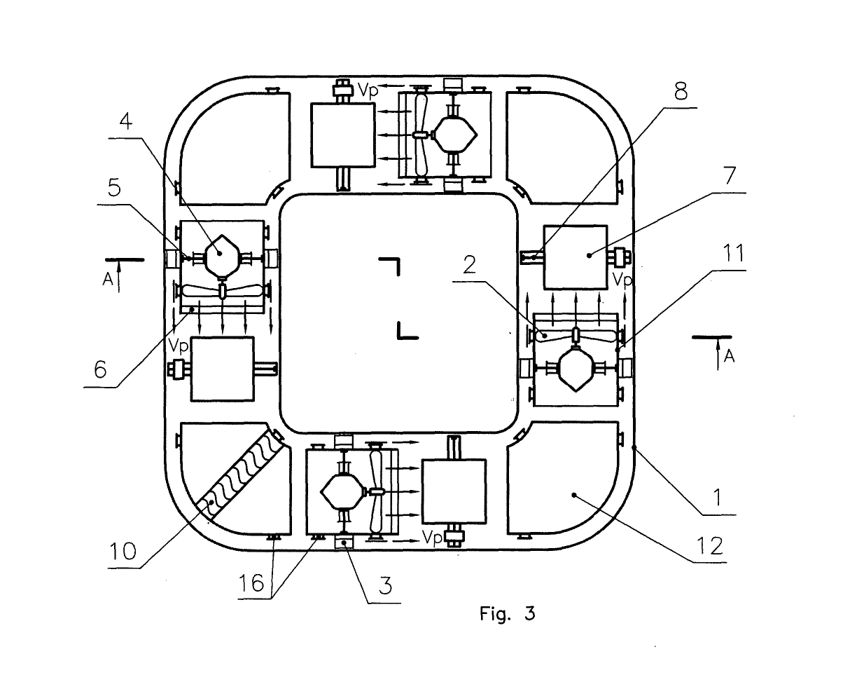

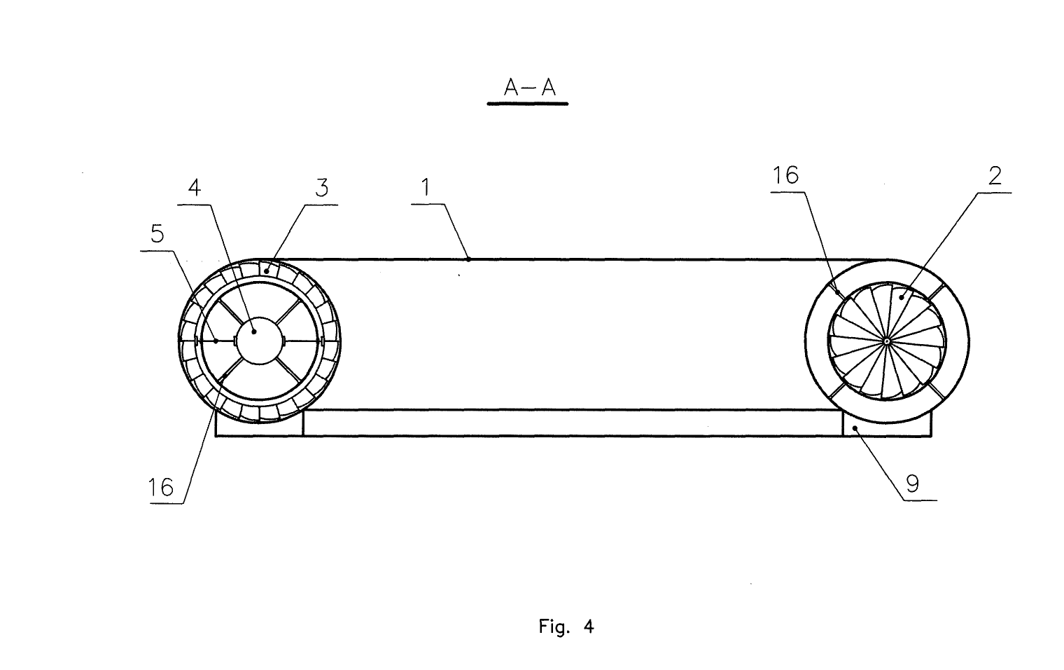

In FIG. 3-4 the diagrams of a device as per the first option are introduced—accordingly incised plane view (FIG. 3), section view A-A (FIG. 4), in this option the arrangement of medium flow along closed loop path is performed via superchargers located inside the tubiform frame in the form of a tore, in which for example, four wings and respectively other elements of a device are contained.

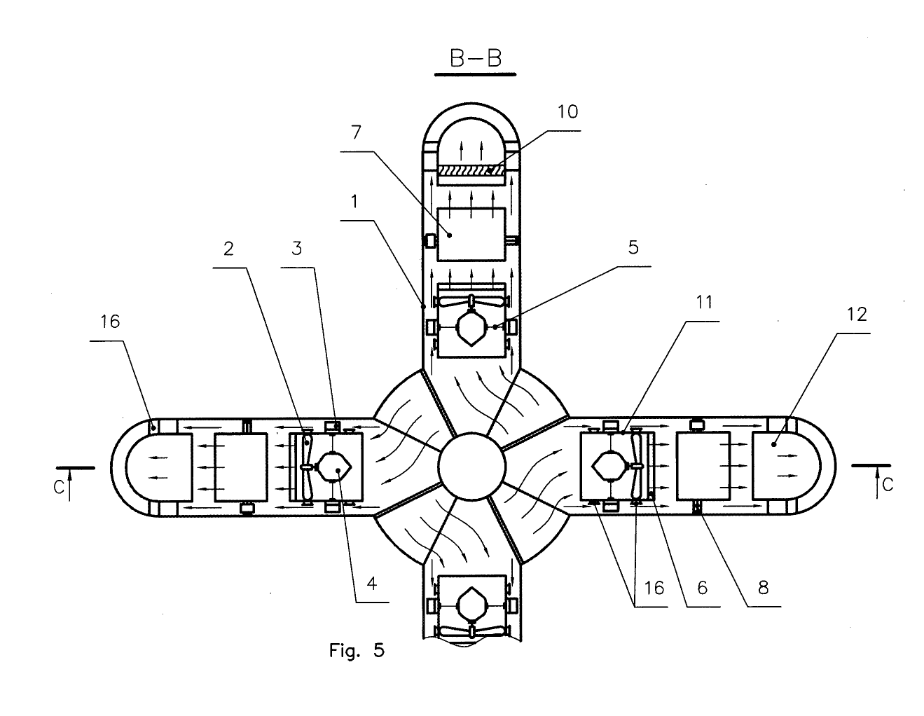

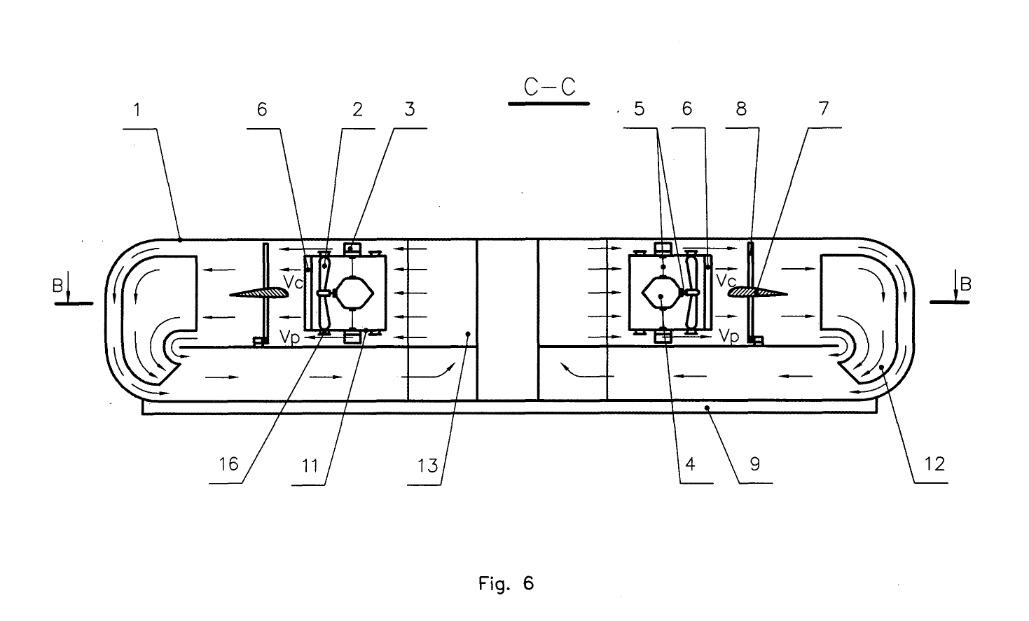

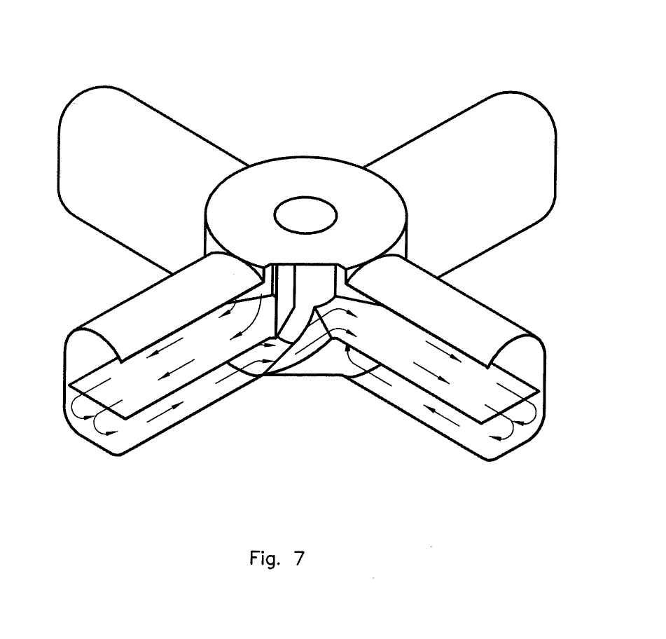

In FIG. 5-7 the diagrams of a device as per the second option are introduced—accordingly incised plane view B-B (FIG. 5), section view C-C (FIG. 6), the movement of a medium flow is shown in FIG. 7, where only those parts of a device construction, which are sufficient to imagine the path of a flow movement are shown. In this option the movement of a medium flow along the closed loop path, converged without crossing in the center of device to deflect the path, in the shape of volumetric loop is performed, where the movement of flow, for example, is performed contra clockwise, going downwards in the peripheral part of a device and arising bottom-up turning in the central part of a device. In the device for example, four wings and respectively other elements of a device are contained.

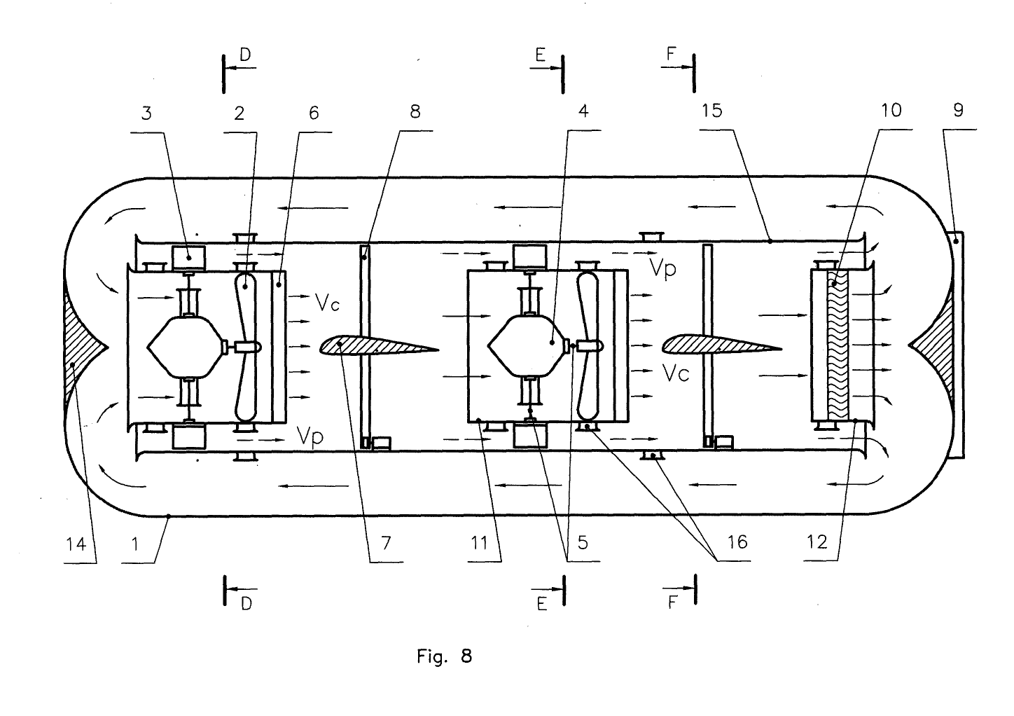

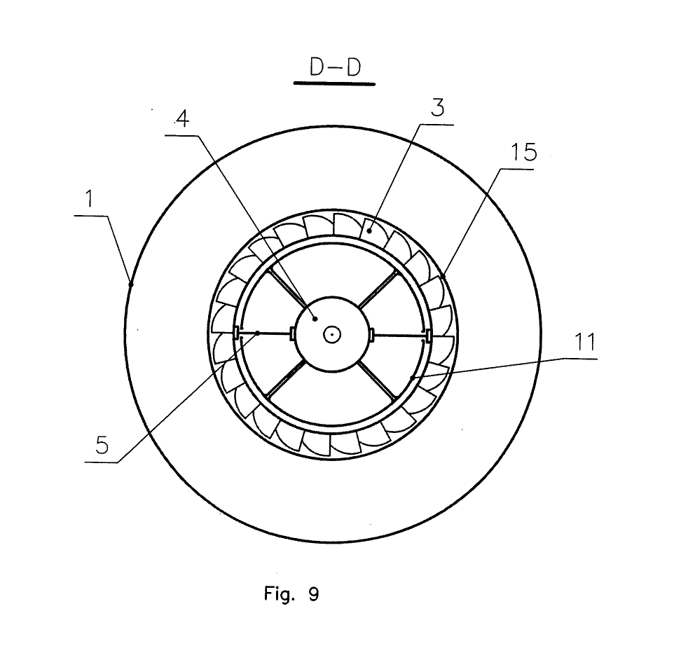

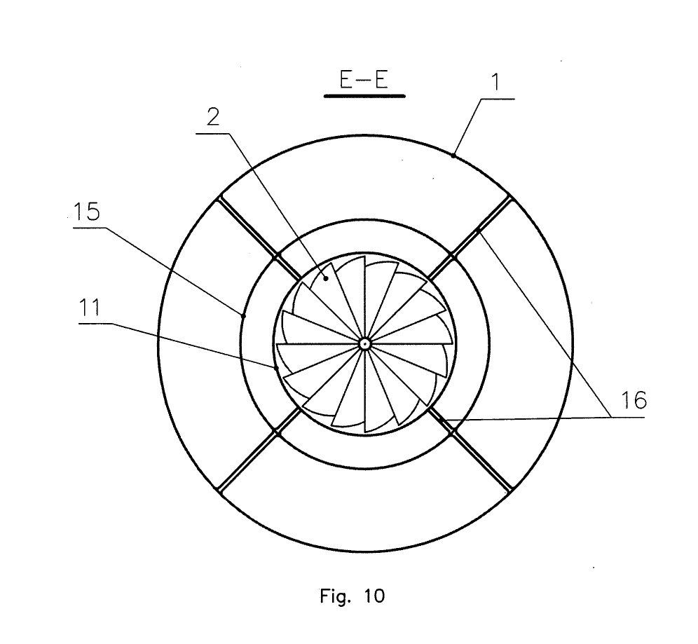

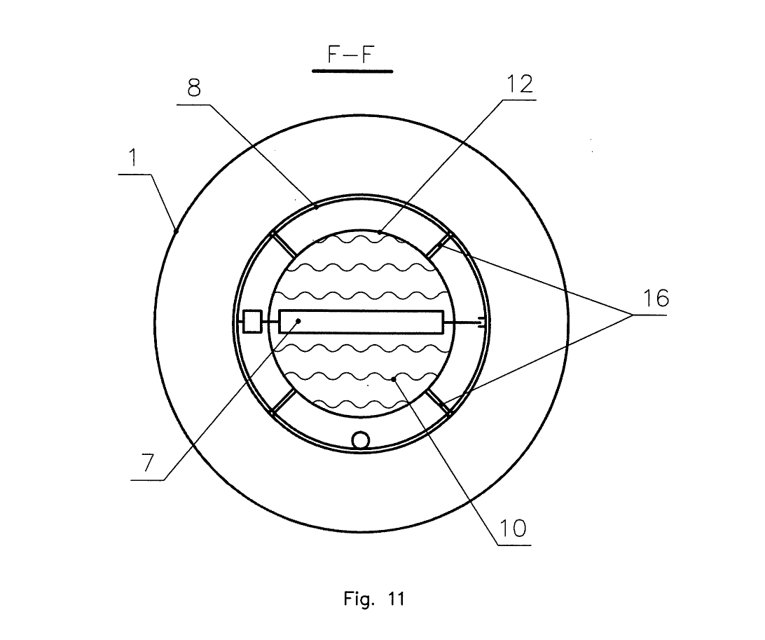

In FIG. 8-11 the diagrams of a device as per the third option are introduced—accordingly incised side view (FIG. 8), section view D-D (FIG. 9), section view E-E (FIG. 10), section view F-F (FIG. 11), in this option the arrangement of medium flow along closed loop path is performed via superchargers, end elements, providing the turn back of working medium flow at 180°, and tubiform partition. In the device for example, two wings and respectively other elements of a device are contained.

### MODES FOR CARRYING OUT THE INVENTION

All three options of a device contain a frame 1, main superchargers 2, peripheral superchargers 3, driving motor 4, drive shaft (power transmission) 5, guiding devices 6, wings 7, are equipped with adjusting units 8 (including special driving motors), unit to connect outdoor environment 9 (for heat and mass exchange), the system to maintain the required working temperature of medium 10, separating tubiform elements 11, additional separating tubiform elements 12.

In case of a device as per the second option it additionally has a central distributive unit to change the path of peripheral and central flow 13.

In case of a device as per the third option, it additionally equipped with end elements 14, having inside profiled surfaces in order to provide the turn back of working medium flow at 180°, profiled in such a manner, that it gives the possibility to decrease the creation of nonstationary aerodynamic processes due to flow turbulence and accordingly decrease energy losses. Furthermore, the third option of a device additionally contains tubiform partition 15, which is rigidly connected with a frame and which is together with end elements, providing the turn back of working medium flow at 180°, serves to arrange the closed loop path of a flow movement.

Main superchargers 2, peripheral superchargers 3, driving motor 4, drive shaft 5, guiding devices 6, wings 7, adjusting units 8, unit to connect outdoor environment 9, the system to maintain the required working temperature of medium 10, separating tubiform elements 11 additional separating tubiform elements 12, a central distributive unit to change the path of peripheral and central flow 13, end elements 14, tubiform partition 15 are rigidly connected with a frame 1 of a device either directly, or through the number of constructional elements for connection 16.

Device to generate lift force operates as follows. In the process of a wing 7 flow-around with a medium flow having in section an aerofoil profile oriented by the leading edge to the direction of working medium exhaust out of the supercharger 2, the lift force is generated at it. As a wing 7 via an adjusting unit is connected with a frame 1, the net lift of wings is transferred to the frame 1.

The velocity profile of central flow is aligned with a guiding device 6, installed in front of a wing leading edge.

A frame 1 provides the movement of working medium along closed loop path. Main supercharger 2 with a driving motor 4 is a flow movement booster and imposes the flow an additional energy. A driving motor 4 is connected with main superchargers 2 via a drive shaft 5.

To generate controlled movement by means of changing the vector of moving aerodynamic net force, including as a component force a lift force, wings 7 are installed with the possibility to occupy any location inside device's frame with the help of adjusting units 8. Such factor simplifies the movement control, permits to manage it without additional aids. Moreover, this factor increases the efficiency of the device movement management, improves stability of device movement towards excitation of outdoor environment considering the capability of wings freely to orient in the axis system, connected with the device.

Under medium speed conditions due to friction, the heating of a working medium takes place. In order optimally to maintain working temperatures of medium it is stipulated joint usage of the system to maintain the required working temperature of medium (for example, heat exchanger) 10 and unit to connect outdoor environment 9. Via the unit to connect outdoor environment 9 the air from the atmosphere enters the device, the air serves as a working medium as well as cooling agent.

In case of a device as per the second option a central distributive unit 13 is used in order to arrange the movement of peripheral and central flows of medium along closed loop path, converged without crossing in the center of device to deflect the path.

In case of a device as per the third option end elements 14 and a tubiform partition 15 are used in order to arrange the movement of peripheral and central flows of medium along closed loop path.

Separating tubiform elements 11 separate through passage area for a working medium into peripheral and central parts.

Main superchargers of a central flow 2 serve to provide steady movement of a working medium in separating tubiform elements 11 with required velocity (V_{c}), but peripheral superchargers of peripheral flow 3 serve to provide the movement of working medium part hyper velocity (Vₚ)—if compare with the velocity of flow in central part (V_{c})—in the extent of area, restricted by a frame 1 and separating tubiform elements 11 for the first and for the second option of a device or in the extent of area, restricted by a frame 1 and a tubiform partition 15 for the third option of a device, due to it negative effect of arising distributed aerodynamic forces on the surface of feedthrough, which arise as <<induced>> (or <<inductive>>) aerodynamic forces, and decrease negative effect disturbed nonstationary (turbulent) flow near the surface of feedthrough on the condition of flow about wings and generating of lift force is considerably decreased. The availability of specified peripheral superchargers 3, with the help of which the movement of peripheral flow with hyper velocity—if compare with the velocity of flow in the central part of the device is provided —is one of the main essential difference of invention and contributes to unity.

In order to optimize some design characteristics for the purpose of removal of disadvantages of compared known analogues with the help of standard calculation-theoretical methods and simulated model tests approved by aerohydromechanics (Physical encyclopedia/Head editor A. M. Prokhorov.—Moscow: Soviet encyclopedia, 1983.—928 pages; Krasnov N. F. Aerodynamics. Part I. Theoretic framework. Aerodynamics of a profile and a wing. Textbook for high technical schools.—M., Vysshaya shkola, 1976.—384 pages; Krasnov N. F. Aerodynamics Part II. Methods of aerodynamic design. Textbook for high technical Schools—3-rd edition, revised and corrected—M., Vysshaya Shkola, 1980—416 pages), the following stated.

Other factors being equal the ranging for proportion S₁/S₂ in the limits not less 0.3 and not more 3.6 permits optimally to decrease negative effect disturbed nonstationary (turbulent) flow, forming near the wall of separating tubiform element on the conditions of flow around of a wing flow and generating of lift force (flow energy consumption to get over nonstationary processes, connected with turbulence, decrease as minimum to 8%).

At S₁/S₂ less 0.3 negative effect disturbed nonstationary (turbulent) flow, forming near the wall of separating tubiform element on the conditions of flow around of a wing with a medium flow and generating of lift force considerably increases.

At S₁/S₂ more 3, negative effect disturbed nonstationary (turbulent) flow, forming near the wall of separating tubiform element on the conditions of flow around of a wing with a medium flow and creation of lift force slightly decreases, meanwhile the material consumption of device increases, that is inadvisable.

Other factors being equal the ranging L₁ in the limits not less 0.8b and not more 2.5b if compare with other values L₁ assigns the zone of optimal values, which takes into consideration the effect of friction forces and inertial forces as well as a flow compressibility. Optimum choice of L₁ permits to negative effect disturbed nonstationary (turbulent) flow, forming near the wall of separating tubiform element on the conditions of flow around of a wing flow and generating of lift force (flow energy consumption to get over nonstationary processes, connected with turbulence, decrease as minimum to 7%).

At L₁ more 2.5b in the flow the increase of instability of speed field of medium flow is takes place due to the action of friction forces, resulting in occurrence and growth of the centers of swirl motion, generated by insufficient smoothing of a flow on the guiding device.

At L₁ less 0.8b because of flow damping capacity in front of the wing leading edge the distortion of uniform velocity space in the zone between the guiding device and leading edge, this impairs the operating conditions of the guiding device and results in the growth of a swirl potential in the flow.

Other factors being equal the ranging of L₂ in the limits not less 0.7b and not more 3b if compare with other values of L₂ assigns the zone of optimal values, which takes into consideration the effect of friction forces and inertial forces as well as a flow compressibility. Optimum choice of L₂ permits to decrease negative effect of disturbed nonstationary (turbulent) flow near the wing trailing edge on the conditions of flow around of a wing flow and generating of lift force (flow energy consumption to get over nonstationary processes, connected with turbulence, decrease as minimum to 6%).

At L₂ more 3b after flow about wing in the medium flow the instability of velocity space, generated by the swirl action, induced by flow separation from the wing trailing edge is increased as well as materials consumption of device is increased.

At L2 less 0.7b the condition of continuity of current-flow line, which is an essential requirement in the process of the occurrence of aerodynamic forces on the wing, is not fulfilled, also in this case it is a great effect of excitations, generated by flow separation on the separating tubiform element behind the wing.

The condition, as per which the device is equipped more than one wing, stipulated by the fact that if there is one wing, the device will be not stable; the management of the forces, which take place in the device is not effective. The choice of the wings' quantity, at which the proposed device operates effectively, is connected with the assigned technical task and depends on weight, geometrical, hydro-aeromechanic parameters of elements of the device and this quantity can be specified with the help of standard calculation-theoretical methods and simulated model tests approved by aerohydromechanics (Physical encyclopedia/Head editor A. M. Prokhorov.—Moscow: Soviet encyclopedia, 1983.—928 pages; Krasnov N. F. Aerodynamics. Part I. Theoretic framework. Aerodynamics of a profile and a wing. Text-book for high technical schools.—M., Vysshaya shkola, 1976.—384 pages; Krasnov N. F. Aerodynamics Part II. Methods of aerodynamic design. Textbook for high technical Schools—3-rd edition, revised and corrected—M., Vysshaya Shkola, 1980—416 pages).

1. The device to generate lift force containing a tubiform frame in the form of a tore, supercharges with driving motors, the wings having in section an aerofoil profile oriented by the leading edge to the direction of working medium exhaust out of the supercharger, adjusting units for a wing, guiding devices, each of those is installed in front of leading edge of each wing, the system to maintain the required working temperature of medium, unit to connect outdoor environment, differed in the matter that it is equipped with more than one wing, inside the frame in front of the leading edge of each wing as per the method <<tube in tube>> rigidly connected with a frame separating tubiform elements, which separate for working medium the through passage area into peripheral and central parts are installed, meanwhile a section area of a central part of through passage area inside separating tubiform element S₁ is connected with a wing area S₂ by a condition 0.3≦S₁/S₂≦3.6, and the largest area of cross section area of a wing by a plane, passing through the longest height of wing shape, is inserted in the section of a central part of the through passage area, guiding devices are installed inside each separating tubiform element in its inlet flow part and rigidly connected with these elements, at the parts where the flow turns the additional separating tubiform elements, equipped from inside of inlet part with the system to maintain the required working temperature of medium are installed, the distance L₁ from the area of flow outlet from the separating tubiform element up to the leading edge of a wing is connected with a wing chord b by condition 0.8b≦L₁≦2.5b, but a distance L₂ from a wing trailing edge up to the flow inlet into separating tubiform element or into the additional separating tubiform element makes a value, which is within the limits 0.7b≦L₂≦3b, main superchargers, oriented by the working medium outlet from the supercharger toward the direction of a wing leading edge, are installed in front of the guiding devices inside the separating tubiform elements in the center and rigidly connected with these elements, meanwhile each wing complies with one main supercharger, but a peripheral superchargers, oriented by the working medium outlet from the supercharger toward the direction of a wing leading edge, are installed in the extent of area, restricted by a frame and separating tubiform elements and rigidly connected with a frame, meanwhile each wing complies with one peripheral supercharger.

2. The device to generate lift force containing tubiform frame in the shape of closed volumetric loop, converged without crossing in the center of device to deflect the path of working medium transmission supercharges with driving motors, the wings having in section an aerofoil profile oriented by the leading edge to the direction of working medium exhaust out of the supercharger, adjusting units for a wing, guiding devices, each of those is installed in front of leading edge of each wing, the system to maintain the required working temperature of medium, unit to connect outdoor environment, differed in the matter that it is equipped with more than one wing, inside the frame in front of the leading edge of each wing as per the method <<tube in tube>> rigidly connected with a frame separating tubiform elements, which separate for working medium the through passage area into peripheral and central parts are installed, meanwhile a section area of a central part of through passage area inside separating tubiform element S₁ is connected with a wing area S₂ by a condition 0.3≦S₁/S₂≦3.6, and the largest area of cross section area of a wing by a plane, passing through the longest height of wing shape, is inserted in the section of a central part of the through passage area, guiding devices are installed inside each separating tubiform element in its inlet flow part and rigidly connected with these elements, at the parts where the flow turns the additional separating tubiform elements, equipped from inside of inlet part with the system to maintain the required working temperature of medium are installed, the distance L₁ from the area of steam outlet from the separating tubiform element up to the leading edge of a wing is connected with a wing chord b by condition 0.8b≦L₁≦2.5b, but a distance L₂ from a wing trailing edge up to the flow inlet into separating tubiform element or into the additional separating tubiform element makes a value, which is within the limits 0.7b≦L₂≦3b, the device in the center is additionally furnished with a central distribution unit in order to change the path of peripheral and central steams, the main superchargers, oriented by the working medium outlet from the supercharger toward the direction of a wing leading edge, are installed in front of the guiding devices inside the separating tubiform elements in the center and rigidly connected with these elements, meanwhile each wing complies with one main supercharger, but a peripheral superchargers, oriented by the working medium outlet from the supercharger toward the direction of a wing leading edge, are installed in the extent of area, restricted by a frame and separating tubiform elements and rigidly connected with a frame, meanwhile each wing complies with one peripheral supercharger.

3. The device to generate lift force containing a tubiform frame, supercharges with driving motors, the wings having in section an aerofoil profile oriented by the leading edge to the direction of working medium exhaust out of the supercharger, adjusting units for a wing, guiding devices, each of those is installed in front of leading edge of each wing, the system to maintain the required working temperature of medium, unit to connect outdoor environment, differed in the matter that a tubiform frame has a cylindrical form with the end elements, having inside profiled surfaces in order to provide the turn back of working medium flow at 180°, the device is equipped with more than one wing, inside the frame in front of the leading edge of each wing as per the method <<tube in tube>> rigidly connected with a frame separating tubiform elements, which separate for working medium the through passage area into peripheral and central parts are installed, meanwhile a section area of a central part of through passage area inside separating tubiform element S₁ is connected with a wing area S₂ by a condition 0.3≦S₁/S₂≦3.6, and the largest area of cross section area of a wing by a plane, passing through the longest height of wing shape, is inserted in the section of a central part of the through passage area, guiding devices are installed inside each separating tubiform element in its inlet flow part and rigidly connected with these elements, at the parts where the flow turns the additional separating tubiform elements, equipped from inside of inlet part with the system to maintain the required working temperature of medium are installed, the distance L₁ from the area of flow outlet from the separating tubiform element up to the leading edge of a wing is connected with a wing chord b by condition 0.8b≦L₁≦2.5b, but a distance L₂ from a wing trailing edge up to the steam inlet into separating tubiform element or into the additional separating tubiform element makes a value, which is within the limits 0.7b≦L₂≦3b, in the extent of area, restricted by a frame and separating tubiform elements, as per the method <<tube in tube>> the tubiform partition is installed, rigidly connected with a frame and which together with end elements serves to arrange medium closed loop path, main superchargers, oriented by the working medium outlet from the supercharger toward the direction of a wing leading edge, are installed in front of the guiding devices inside the separating tubiform elements in the center and rigidly connected with these elements, meanwhile each wing complies with one main supercharger, but a peripheral superchargers, oriented by the working medium outlet from the supercharger toward the direction of a wing leading edge, are installed in the extent of area, restricted by a tubiform partition and separating tubiform elements and rigidly connected with a frame, meanwhile each wing complies with one peripheral supercharger.
